(19) United States
(12) Patent Application Publication
(10) Pub. No.: US 2022/0372247 A1
(43) Pub. Date: Nov. 24, 2022

(54) Storage-stable hardener composition for a reaction resin

(71) Applicant: Hilti Aktiengesellschaft, Schaan (LI)

(72) Inventors: Memet-Emin Kumru, Augsburg (DE); Thomas Bürgel, Landsberg (DE)

(73) Assignee: Hilti Aktiengesellschaft, Schaan (LI)

(21) Appl. No.: 17/754,617

(22) PCT Filed: Sep. 30, 2020
(86) PCT No.: PCT/EP2020/077300

§ 371 Date: Apr. 7, 2022

(30) Foreign Application Priority Data
Oct. 10, 2019 (EP) 19202360.4

(51) Int. Cl. C08K 5/14; C08K 3/34

(52) U.S. Cl. CPC C08K 5/14; C08K 3/346

(57) ABSTRACT

A storage-stable hardener composition, for a reaction resin based on a radically curable compound, contains water, a peroxide, and a rheology additive. The rheology additive is based on a phyllosilicate. A reaction resin system contains said hardener composition as a hardener component, and a resin component containing a reaction resin based on radically curable compounds. The reaction resin system is used with a thread-forming screw.

The invention relates to a hardener composition for a reaction resin for use with thread-forming screws, in particular a storage-stable hardener composition based on a peroxide-water system.

The at least two-component mortar compositions used for chemical fastening technology generally contain in one component, i.e. the resin component, a resin hardenable by radical polymerization, for example an unsaturated polyester resin, an epoxy acrylate resin or a urethane methacrylate resin, which resins can be dissolved in copolymerizable reactive diluents such as styrene or monomeric methacrylates. In addition to the resin, this resin component usually contains further additives such as accelerators, inhibitors and the like, as well as fillers or thickeners.

The second necessary component of such a mortar composition for chemical fastening technology, i.e. the hardener component, contains the radical former necessary for the polymerization of the hardenable resin, for example a peroxide. Since the amount of radical former required for the radical polymerization of the resin component is very much less than the amount of the resin in the resin component and the radical formers, namely the peroxides, can decompose explosively, the hardener component usually contains a carrier material or phlegmatizer by means of which the volume of the hardener component is brought to a reasonable value and the risk of explosion of the radical former is reduced. The hardener component thus consists of or contains a hardener composition.

Finally, it is possible to provide further constituents which react chemically with the resin component and the hardener component in one or more further components in which these constituents are separated from one another so that no premature reaction can occur.

When used as intended, the spatially separated components, namely the resin component and the hardener component, are mixed in separate containers, e.g. multi-chamber bags, during use by the multi-chamber bag being inserted into the borehole and the container being comminuted and the components contained therein being mixed by a corresponding fastening element, for example a thread-forming screw, being introduced in a rotating manner.

This type of use of a reaction resin results in different requirements for the properties of both the individual components and the mixture thereof than does use with injection devices, in which the compound is mixed before being introduced into the borehole.

Problems arise because, as a rule, the amount of hardener, i.e. of the radical former, such as the peroxide, is much less than the amount of resin in the resin component, which makes it much more difficult to homogeneously mix these two constituents, as is necessary to achieve consistently good and reproducible strength values. In addition, certain radical formers, for example dibenzoyl peroxide, are solid, such that the hardener composition usually contains a diluent in order to either dissolve or disperse the radical generator and present it overall in a larger volume that can be mixed more easily with the resin component. In this context, volume ratios of resin component to hardener component of 7:1 to 1:1 are conventional, although this has the consequence that non-negligible amounts of liquid carrier material must be added to the hardener composition and thus to the hardener component in order to set this volume ratio.

If the reaction resin system is used as intended, i.e. with a thread-forming screw, the screw is placed in a borehole previously filled with a hardenable compound. Here, the annular gap between the outer surface of the main body and the wall of the borehole is too small for most types of hardenable compounds that are filled with inorganic fillers to a great extent. It is thus only possible to use low-viscosity, hardenable masses, which are relatively expensive and have a lower strength compared to hardenable masses with fillers.

The shell systems known for anchor rods, such as those known from EP 0 431 302 A2, EP 0 432 087 A1, EP 0 312 776 A1 or EP 0 638 705 A1, are, due to the very small annular gap, unsuitable for use with self-tapping screws because either they contain excessively coarse-grained fillers or the shells cannot be crushed with conventional thread-forming screws or the shells themselves produce excessively large particles when crushed. Since only a few turns of the screw are possible in this application before the screw is set, rapid mixing of the hardenable mass must be ensured so that said mass hardens reliably, which was previously not possible with the known masses. Sufficiently low-viscosity components are required for this.

According to the prior art, what are referred to as phlegmatizers are used to adjust the flowability and the concentration of the radical former in the hardener composition or the volume of the hardener composition, which phlegmatizers act as a diluent and also avoid undesired decomposition of the radical former. Various types of non-reactive plasticizers, for example dicarboxylic acid esters such as dioctyl phthalate, dioctyl adipate, liquid polyesters or polyalkylene glycol derivatives, have already been used as such phlegmatizers, for which reference can be made to DE 32 26 602 A1, EP 0 432 087 A1 and EP 1 371 671 A1. The disadvantage of the phlegmatizers is that they act as plasticizers in the hardened mortar.

An organic/inorganic hybrid system is also known from DE 42 31 161 A1, which system makes it possible to use water as a phlegmatizer. This has the advantage that after the components have been mixed, the water is bound by the hydraulically condensable compounds that are present and thus no longer has a plasticizing function in the hardened mass.

A disadvantage of the aqueous hybrid system, however, is that the preparation of a hardener composition formulated on this basis is complex, since the peroxides phlegmatized with water are not sedimentation-stable. The hardener compositions have to be stirred up and thickened additives added before filling. However, the hardener compositions obtained in this way are too viscous for use with thread-forming screws, so that the conventional thickeners, such as fumed silicas, cannot be used.

It has now been shown that the conventional approaches to the formation of the hardener composition as a hardener component of such an at least two-component mortar composition for use with thread-forming screws are not able to be fully satisfactory, because either the viscosity of the conventional hardener compositions is too high to be used with thread-forming screws or, if the viscosity is sufficiently low, the stability is unsatisfactory, particularly with regard to the sedimentation of the solid peroxides.

The object of the present invention is therefore to provide a hardener composition for use as a hardener component for an at least two-component mortar composition, by means of which composition it is possible not only to achieve the necessary flowability of the hardener component for use with thread-forming screws in a simple manner, but also to achieve high stability of the hardener component.

It has been shown that this object can be achieved in that the hardener composition contains water and a rheology additive based on a phyllosilicate in addition to the radical former.

For better understanding of the invention, the following explanations of the terminology used herein are considered to be useful. Within the meaning of the invention:
“reaction resin mixture” means a mixture of at least one reaction resin and/or at least one reactive diluent; the mixture can optionally contain an accelerator and/or an inhibitor;
“reaction resin based on a radically curable compound,” also called “reaction resin” or “base resin” for short, means a usually solid or high-viscosity “radically curable,” i.e. radically polymerizable, compound, which hardens through polymerization and forms a resin matrix; the reaction resin is the reaction product of a bulk reaction per se; this also includes the reaction batch for producing the base resin after the reaction has ended, which is present without isolation of the product and therefore can contain the reaction resin, a reactive diluent, a stabilizer and a catalyst, if used, in addition to the radically curable compound;
“reactive diluents” means liquid or low-viscosity monomers and oligomers which dilute the reaction resin and thereby impart the viscosity necessary for application thereof, which contain functional groups capable of reacting with the reaction resin, and which for the most part become a constituent of the hardened composition during the polymerization (hardening);
“inhibitor” means a compound capable of inhibiting the polymerization reaction (hardening), which compound serves to avoid the polymerization reaction and thus an undesired premature polymerization of the reaction resin during storage (in this function, often also referred to as a stabilizer) and/or the start of the polymerization reaction delay immediately after adding the hardening agent; the task of the inhibitor depends on the quantities in which it is used;
“hardening agent” means a substance that causes or initiates the polymerization (hardening) of the radically curable compound, such as the reaction resin;
“accelerator” means a compound capable of accelerating the polymerization reaction (hardening), which compound is used to accelerate the formation of radicals, in particular from the hardening agent, i.e. to activate the hardening agent more rapidly;
“solid peroxide” means a substance (hardening agent) which has a solid physical state at a temperature of 20° C. and contains a peroxy group —O—O— that is homolytic with low energy expenditure, e,g. can be split by exposure to light (photolytic) or the supply of heat (thermolytic); here, two radical fragments are formed, which can start a radical reaction (e.g. polymerization);
“resin component” means a mixture of the reaction resin and inorganic and/or organic added substances (fillers and additives), such as an inhibitor and/or an accelerator;
“hardener composition” means a mixture of the hardening agent and inorganic and/or organic added substances (fillers and additives), such as a phlegmatizer, i.e. a stabilizer for the hardening agent;
“hardener component” means the component of a two-component or multi-component reaction resin system. which consists of the hardener composition or contains said composition as a constituent;
“filler” means an organic or inorganic, in particular inorganic compound that can be passive and/or reactive and/or functional; “passive” means that the connection is surrounded unchanged by the hardening resin matrix; “reactive” means that the compound polymerizes into the resin matrix and forms an expanded network with the resin components; “functional” means that the compound is not polymerized into the resin matrix but fulfills a certain function in the formulation;
“two-component reaction resin system” means a reaction resin system comprising two separately stored components, generally a reactive resin component and a hardener component, so that hardening of the reaction resin takes place only after the mixing of the two components;
“multi-component reaction resin system” means a reaction resin system comprising a plurality of separately stored components, so that hardening of the reaction resin takes place only after all of the components are mixed;
“(meth)acryl . . . / . . . (meth)acryl . . . ” encompasses both the “methacryl . . . / . . . methacryl . . . ” and the “acryl . . . / . . . acryl . . . ” compounds; “methacryl . . . / . . . methacryl . . . ” compounds are preferred in the present invention;
“a” or “an” as the article preceding a class of chemical compounds, e.g. preceding the word “reactive diluent,” means that one or more compounds included in this class of chemical compounds, e.g. various “reactive diluents,” may be intended;
“at least one” means numerically “one or more”; in a preferred embodiment, the term means numerically “one”;
“contain,” “comprise,” and “include” mean that further constituents may be present in addition to those mentioned. These terms are intended to be inclusive and therefore also encompass “consist of.” “Consist of” is intended to be exclusive and means that no further constituents may be present. In a preferred embodiment, the terms “contain,” “comprise” and “include” mean the term “consist of.”

A first object of the invention is the hardener composition according to claim 1. Dependent claims 2 to 9 relate to preferred embodiments of this subject matter of the invention.

A second object of the invention is also a multi-component reaction resin system according to claim 10, having a resin component comprising a radically curable compound, and having a hardener composition comprising a hardener composition according to claim 1. The further dependent claims 11 to 16 relate to preferred embodiments of this subject matter of the invention.

A third object of the invention is also the use of the multi-component mortar composition according to claim 17 for fastening and/or reinforcing thread-forming screws in solid substrates, in particular in stone or concrete.

The hardener composition according to the invention contains, in addition to water as a phlegmatizer, solid peroxide as a radical former, preferably an organic peroxide. Particularly preferred solid peroxides are selected from the group consisting of alkyl peroxides, dialkyl peroxides, diacyl peroxides, alkyl hydroperoxides, hydroperoxides, percarbonates, perketals and inorganic peroxides, if these are solid. According to a most preferred embodiment, the hardener composition contains diacetyl peroxide, di-p-chlorobenzoyl peroxide, phthaloyl peroxide, succinyl peroxide, dilauryl peroxide, acetylcyclohexanesulfonyl peroxide, cyclohexane percarbonate, bis(4-t-butylcyclohexyl) percarbonate, a silicon peroxide, cyclohexanone peroxide, dibenzoyl peroxide and/or dilauroyl peroxide. The use of diacyl peroxides, such as dibenzoyl peroxide or dilauroyl peroxide, is particularly preferred for processing in a temperature range of −25° C. to +60° C. and thus on conventional outdoor construction sites.

The peroxide is preferably present as a suspension together with the water. Corresponding suspensions are commercially available in different concentrations, such as, for example, the aqueous dibenzoyl peroxide suspensions from United Initiators (BP20SAQ, BP40SAQ). Perkadox 40L-W (Nouryon), Luperox® EZ-FLO (Arkema), Peroxan BP40W (Pergan).

The peroxide can be contained in the reaction resin system in an amount of 2 to 50 wt. %, preferably 5 to 45 wt. %, particularly preferably 10 to 40 wt. %, based on the resin component.

The hardener composition according to the invention contains, as rheology additive, a rheology additive based on a phyllosilicate, in particular an activated or swellable phyllosilicate. The swellable phyllosilicate is particularly preferably a magnesium aluminum silicate or a sodium aluminum silicate.

In a preferred embodiment, the rheology additive consists of the swellable phyllosilicate or contains this as the main constituent. “Main constituent” means that the swellable phyllosilicate makes up more than half of the rheology additive, i.e. more than 50 wt. %, in particular 60 to 80 wt. %. The remainder is made up of other minerals, such as clay minerals, in particular accompanying minerals.

The rheology additive montmorillonite is particularly preferred or contains this as the main constituent, for example bentonite.

The amount of rheology additive to be used depends substantially on the amount of water, a person skilled in the art being able to select the correct ratio of these constituents and the constituents to be optionally used such that the hardener composition has the required viscosity and flowability. The hardener composition preferably contains the rheology additive in an amount of 0.15 to 5 wt. %, particularly preferably 1 to 3 wt. %, based on the total weight of the hardener composition.

In an alternative embodiment, a further inorganic thickener, in particular based on silica, such as, for example, a hydrophilic fumed silica, can be added to the rheology additive.

In addition to the rheology additive based on a phyllosilicate, the hardener composition according to the invention preferably contains no further added substances, such as fillers and/or additives.

The rheology additive is very particularly preferably free from organic thickeners, in particular polysaccharides such as xanthan gum or cellulose.

In addition to the ingredients just mentioned, the hardener composition can also contain further additives such as surfactants, emulsifiers, antifreeze agents, buffers and the like.

Nevertheless, in addition to the rheology additive based on a phyllosilicate, the hardener composition can contain the fillers described below for the resin component in small amounts. The amounts are to be selected so that the properties, such as viscosity or flowability and the like, of the hardener composition or a hardener component containing said composition, and in particular the stability of the hardener composition or a hardener component containing said composition, are not adversely affected.

The water is contained in such an amount that, depending on the constituents of the hardener composition, the weight percent adds up to 100.

The hardener composition according to the invention can be used as a hardener component in a multi-component reaction resin system, which also includes two-component reaction resin systems.

The invention accordingly also relates to a multi-component reaction resin system comprising a resin component and the hardener composition described above as the hardener component. The resin component contains at least one radically curable compound. The radically curable compound may be a reaction resin. Alternatively, the one radically curable compound may be a reactive diluent. According to a further alternative, the radically curable compound can also comprise a mixture of at least one reaction resin and at least one reactive diluent, a reaction resin mixture.

Suitable radically curable compounds as a reaction resin are ethylenically unsaturated compounds, compounds which have carbon-carbon triple bonds, and thiol-yne/ene resins, as are known to a person skilled in the art.

Particularly preferably, the radically curable compound, the reaction resin, is an unsaturated compound based on urethane (meth)acrylate, epoxy (meth)acrylate, a (meth)acrylate of an alkoxylated bisphenol or a compound based on further ethylenically unsaturated compounds.

Of these compounds, the group of ethylenically unsaturated compounds is preferred, which group comprises styrene and derivatives thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins are particularly suitable and are described, for example, in applications EP 1 935 860 A1, DE 195 31 649 A1, WO 02/051903 A1 and WO 10/108939 A1. Vinyl ester resins (synonym: (meth)acrylate resins) are in this case most preferred due to the hydrolytic resistance and excellent mechanical properties thereof. Vinyl ester urethane resins, in particular urethane methacrylates, are very particularly preferred. These include, as preferred resins, the urethane methacrylate resins described in DE 10 2011 017 626 B4. In this regard, DE 10 2011 017 626 B4, and above all its description of the composition of these resins, in particular in the examples of DE 10 2011 017 626 84, is hereby incorporated by reference.

Examples of suitable unsaturated polyesters which can be used according to the invention are divided into the following categories, as classified by M. Malik et al. in J. M. S.—Rev. Macromol. Chem. Phys., C40 (2 and 3), p. 139-165 (2000):

(1) ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;

(2) iso-resins: these are prepared from isophthalic acid, maleic anhydride or fumaric acid and glycols, These resins can contain higher proportions of reactive diluents than the ortho resins;

(3) bisphenol A fumarates: these are based on ethoxylated bisphenol A and fumaric acid;

(4) HET acid resins (hexachloroendomethylene tetrahydrophthalic acid resins): these are resins obtained from chlorine/bromine-containing anhydrides or phenols during the preparation of unsaturated polyester resins,

In addition to these resin classes, what are referred to as dicyclopentadiene resins (DCPD resins) can also be distinguished as unsaturated polyester resins, The class of DCPD resins is either obtained by modifying one of the above-mentioned resin types by means of a Diels-Alder reaction with cyclopentadiene, or said resins are alternatively obtained by means of a first reaction of a dicarboxylic acid, for example maleic acid, with dicyclopentadienyl and then by means of a second reaction of the usual preparation of an unsaturated polyester resin, the latter being referred to as a DCPD maleate resin.

The unsaturated polyester resin preferably has a molecular weight Mn in the range of 500 to 10,000 daltons, more preferably in the range of 500 to 5,000 and even more preferably in the range of 750 to 4,000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as the unsaturated polyester resin, the acid value is preferably 0 to 50 mg KOH/g resin.

In the context of the invention, vinyl ester resins are oligomers, prepolymers or polymers having at least one (meth)acrylate end group, what are referred to as (meth)acrylate-functionalized resins, which also include urethane (meth)acrylate resins and epoxy (meth)acrylates.

Vinyl ester resins, which have unsaturated groups only in the end position, are obtained, for example, by reacting epoxy oligomers or polymers (for example bisphenol A digylcidyl ether, phenol novolac-type epoxies or epoxy oligomers based on tetrabromobisphenol A) with (meth)acrylic acid or (meth)acrylamide, for example. Preferred vinyl ester resins are (meth)acrylate-functionalized resins and resins which are obtained by reacting epoxy oligomers or polymers with methacrylic acid or methacrylamide, preferably with methacrylic acid, and optionally with a chain extender, such as diethylene glycol or dipropylene glycol. Examples of such compounds are known from applications U.S. Pat. Nos. 3,297,745 A, 3,772,404 A, 4,618,658 A, GB 2 217 722 A1, DE 37 44 390 A1 and DE 41 31 457 A1.

Particularly suitable and preferred vinyl ester resins are (meth)acrylate-functionalized resins, which are obtained, for example, by reacting difunctional and/or higher-functional isocyanates with suitable acrylic compounds, optionally with the help of hydroxy compounds that contain at least two hydroxyl groups, as described for example in DE 3940309 A1. Very particularly suitable and preferred are the urethane methacrylate resins (which are also referred to as vinyl ester urethane resins) described in DE 10 2011 017 626 B4, the composition of which is incorporated herein by reference.

Aliphatic (cyclic or linear) and/or aromatic difunctional or higher functional isocyanates or prepolymers thereof can be used as isocyanates. The use of such compounds serves to increase the wettability and thus to improve the adhesive properties. Aromatic difunctional or higher functional isocyanates or prepolymers thereof are preferred, aromatic difunctional or higher functional prepolymers being particularly preferred. Toluylene diisocyanate (TDI), diisocyanatodiphenylmethane (MDI) and polymeric diisocyanatodiphenylmethane (pMDI) for increasing chain stiffening, and hexane diisocyanate (HDI) and isophorone diisocyanate (IPDI), which improve flexibility, may be mentioned, of which polymeric diisocyanatodiphenylmethane (pMDI) is very particularly preferred.

Suitable acrylic compounds are acrylic acid and acrylic acids substituted on the hydrocarbon group, such as methacrylic acid, hydroxyl-containing esters of acrylic or methacrylic acid with polyhydric alcohols, pentaerythritol tri(meth)acrylate, glycerol di(meth)acrylate, such as trimethylolpropane di(meth)acrylate or neopentyl glycol mono(meth)acrylate. Acrylic or methacrylic acid hydroxyalkyl esters, such as hydroxyethyl (meth)acrylate, hydroxypropyl (meth)acrylate, polyoxyethylene (meth)acrylate, polyoxypropylene (meth)acrylate, are preferred, especially since such compounds serve to sterically prevent the saponification reaction. Acrylic acid is less preferred because of its lower alkali stability than acrylic acids substituted on the hydrocarbon group.

Hydroxy compounds that can optionally be used are suitable dihydric or higher alcohols, for example secondary products of ethylene or propylene oxide, such as ethanediol, di- or triethylene glycol, propanediol, dipropylene glycol, other diols, such as 1,4-butanediol, 1,6-hexanediol, neopentyl glycol, diethanolamine, further bisphenol A or F or the ethoxylation/propoxylation and/or hydrogenation or halogenation products thereof, higher alcohols such as glycerol, trimethylolpropane, hexanetriol and pentaerythritol, hydroxyl-containing polyethers, for example oligomers of aliphatic or aromatic oxiranes and/or higher cyclic ethers, such as ethylene oxide, propylene oxide, styrene oxide and furan, polyethers which contain aromatic structural units in the main chain, such as those of bisphenol A or F, hydroxyl group-containing polyesters based on the above-mentioned alcohols or polyethers and dicarboxylic acids or the anhydrides thereof, such as adipic acid, phthalic acid, tetra- or hexahydrophthalic acid, heteric acid, maleic acid, fumaric acid, itaconic acid, sebacic acid and the like. Particularly preferred are hydroxy compounds having aromatic structural units to reinforce the chain of the resin, hydroxy compounds containing unsaturated structural units, such as fumaric acid, to increase the crosslinking density, branched or star-shaped hydroxy compounds, in particular trihydric or higher alcohols and/or polyethers or polyesters containing the structural units thereof, branched or star-shaped urethane (meth)acrylates to achieve lower viscosity of the resins or their solutions in reactive diluents and higher reactivity and crosslinking density.

The vinyl ester resin preferably has a molecular weight Mn in the range of 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

All of these reaction resins that can be used according to the invention as radically curable compounds can be modified according to methods known to a person skilled in the art, for example to achieve lower acid numbers, hydroxide numbers or anhydride numbers, or can be made more flexible by introducing flexible units into the backbone, and the like.

In addition, the reaction resin may contain other reactive groups that can be polymerized with a radical initiator, such as peroxides, for example reactive groups derived from itaconic acid, citraconic acid and allylic groups and the like.

In an embodiment, the resin component of the reaction resin system contains, in addition to the reaction resin, at least one further low-viscosity, radically polymerizable compound as a reactive diluent. This is expediently added to the reaction resin and is therefore contained in the resin component.

Suitable, in particular low-viscosity, radically curable compounds as reactive diluents are described in applications EP 1 935 860 A1 and DE 195 31 649 A1. The reaction resin system preferably contains a (meth)acrylic acid ester as a reactive diluent, the following (meth)acrylic acid esters being particularly preferably used: hydroxyalkyl (meth)acrylates such as hydroxypropyl (meth)acrylate, 2-hydroxyethyl (meth)acrylate; alkanediol (meth)acrylates such as ethanediol-1,2-di(meth)acrylate, propanediol-1,3-di(meth)acrylate, butanediol-1,2-di(meth)acrylate, butanediol-1,3-di(meth) acrylate, butanediol-1,4-di(meth)acrylate, hexanediol-1,6-di(meth)acrylate, 2-ethylhexyl (meth)acrylate, phenylethyl (meth)acrylate, tetrahydrofurfuryl (meth)acrylate: trimethylolpropane tri(meth)acrylate; ethyl triglycol (meth)acrylate; N,N-dimethylaminoethyl (meth)acrylate; N,N-dimethylaminomethyl (meth)acrylate; acetoacetoxyethyl (meth)acrylate; alkylene (meth)acrylates such as ethylene and diethylene glycol di(meth)acrylate; oligo- and polyalkylene glycol di(meth)acrylates such as PEG200 di(meth)acrylate; methoxy polyethylene glycol mono(meth)acrylate; trimethylcyclohexyl (meth)acrylate; dicyclopentenyloxyethyl (meth)acrylate; tricyclopentadienyl di(meth)acrylate; dicyclopentenyloxyethyl crotonate; bisphenol A (meth)acrylate; novolac epoxy di(meth)acrylate: di-[(meth)acryloyl-maleoyl]-tricyclo-5.2.1.0.^{2.6} decane; 3-(meth)acryloyl-oxymethyl-tricylo-5.2.1.0.^{2.6} decane; 3-(meth)cyclopentadienyl (meth)acrylate; isobornyl (meth)acrylate; decalyl 2-(meth)acrylate; tetrahydrofurfuryl (meth)acrylate; and alkoxylated tri-, tetra- and pentamethylacrylates.

In principle, other conventional radically polymerizable compounds, alone or in a mixture with the (meth)acrylic acid esters described in the preceding paragraph, can also be used, e.g. styrene, α-methylstyrene, alkylated styrenes, such as tert-butylstyrene, divinylbenzene and vinyl and allyl compounds. Examples of vinyl or allyl compounds of this kind are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ether, mono-, di-, tri-, tetra- and polyalkylene glycol allyl ether, adipic acid divinyl ester, trimethylolpropane diallyl ether and trimethylolpropane triallyl ether.

Preferred reactive diluents are the further reactive diluents used in the examples.

The radically curable compound can be contained in the reaction resin system in an amount of 10 to 99.99 wt. %, preferably 15 to 97 wt. %, particularly preferably 30 to 95 wt. %, based on the resin component. The radically curable compound can be either a reaction resin based on a radically curable compound or a reactive diluent or a mixture of a reaction resin with two or more reactive diluents.

In the event that the radically curable compound is a reaction resin mixture, then the amount of the mixture that can be contained in the reaction resin system corresponds to the amount of the radically curable compound, namely from 10 to 99.99 wt. %, preferably 15 to 97 wt. %, particularly preferably 30 to 95 wt. %, based on the resin component, the proportion of the reaction resin being 0 to 100 wt. %, preferably 30 to 65 wt. % and the proportion of the reactive diluent or a mixture of several reactive diluents is 0 to 100 wt. %, preferably 35 to 70 wt,%, based on the reaction resin mixture.

The total amount of the radically curable compound depends on the degree of filling, i.e. the amount of inorganic fillers, including the fillers listed below, in particular the hydrophilic fillers, the other inorganic added substances and the hydraulically setting or polycondensable compounds.

In a further embodiment, the resin component of the reaction resin system according to the invention also contains at least one accelerator. This accelerates the hardening reaction.

Suitable accelerators are known to a person skilled in the art. These are expediently amines.

Suitable amines are selected from the following compounds, which are described in application US 2011071234 A1, for example: Dimethylamine, trimethylamine, ethylamine, diethylamine, triethylamine, n-propylamine, di-n-propylamine, tri-n-propylamine, iso-propylamine, di-iso-propylamine, tri-iso-propylamine, n-butylamine, iso-butylamine, tert-butylamine, di-n-butylamine, di-iso-butylamine, tri-iso-butylamine, pentylamine, iso-pentylamine, di-iso-pentylamine, hexylamine, octylamine, dodecylamine, laurylamine, stearylamine, aminoethanol, diethanolamine, triethanolamine, aminohexanol, ethoxyaminoethane, dimethyl(2-chloroethyl)amine, 2-ethylhexylamine, bis(2-chloroethyl)amine, 2-ethylhexylamine, bis(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, dipropylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis(2-hydroxyethyl)oleylamine, tris[2(2-hydroxyethoxy)ethyl]amine, 3-amino-1-propanol, methyl(3-aminopropyl)ether, ethyl-(3-aminopropyl)ether, 1,4-butanediol-bis(3-aminopropyl ether), 3-dimethylamino-1-propanol, 1-amino-2-propanol, 1-diethylamino-2-propanol, di-iso-propanolamine, methyl-bis(2-hydroxypropyl)amine, tris(2-hydroxypropyl)amine, 4-amino-2-butanol, 2-amino-2-methylpropanol, 2-amino-2-methylpropanediol, 2-amino-2-hydroxymethylpropanediol, 5-diethylamino-2-pentanone, 3-methylaminopropionitrile, 6-aminohexanoic acid, 11-aminoundecanoic acid, 6-aminohexanoic acid ethyl ester, 11-aminohexanoate-isopropyl ester, cyclohexylamine, N-methylcyclohexylamine, N,N-dimethylcyclohexylamine, dicyclohexylamine, N-ethylcyclohexylamine, N-(2-hydroxyethyl)cyclohexylamine, N,N-bis(2-hydroxyethyl)cyclohexylamine, N-(3-aminopropyl)cyclohexylamine, aminomethylcyclohexane, hexahydrotoluidine, hexahydrobenzylamine, aniline, N-methylaniline, N,N-dimethylaniline, N,N-diethylaniline, N,N-di-propylaniline, iso-butylaniline, toluidine, diphenylamine, hydroxyethylaniline, bis(hydroxyethyl)aniline, chloroaniline, aminophenols, aminobenzoic acids and esters thereof, benzylamine, dibenzylamine, tribenzylamine, methyldibenzylamine, α-phenylethylamine, xylidine, di-iso-propylaniline, dodecylaniline, aminonaphthalene, N-methylaminonaphthalene, N,N-dimethylaminonaphthalene, N,N-dibenzylnaphthalene, diaminocyclohexane, 4,4′-diamino-dicyclohexylmethane, diamino-dimethyl-dicyclohexylmethane, phenylenediamine, xylylenediamine, diaminobiphenyl, naphthalenediamines, benzidines, 2,2-bis(aminophenyl)propane, aminoanisoles, aminothiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

Preferred amines are aniline and toluidine derivatives and N,N-bisalkylarylamines, such as N,N-dimethylaniline, N,N-diethylaniline, N,N-dimethyl-p-toluidine, N,N-bis(hydroxyalkyl)arylamine, N,N-bis(2-hydroxyethyl)aniline, N,N-bis(2-hydroxyethyl)toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine and 4,4′-bis(dimethylamino)diphenylmethane.

Polymeric amines, such as those obtained by polycondensation of N,N-bis(hydroxyalkyl)aniline with dicarboxylic acids or by polyaddition of ethylene oxide and these amines, are also suitable as accelerators.

Preferred accelerators are N,N-bis(2-hydroxypropyl) toluidine, N,N-bis(2-hydroxyethyl) toluidine and para-toluidine ethoxylate (Bisomer® PTE).

The accelerator can be contained in the reaction resin system in an amount of 0 to 10 wt. %, preferably 0.01 to 5 wt. %, particularly preferably 0.5 to 3 wt. %, based on the resin component.

In yet another embodiment, the resin component of the reaction resin system according to the invention also contains an inhibitor both for the storage stability of the resin component and for setting the gel time. The inhibitor can be contained in the reaction resin system alone or together with the accelerator. A suitably coordinated accelerator-inhibitor combination is preferably used to set the processing time or gel time.

The inhibitors which are conventionally used for radically polymerizable compounds, as are known to a person skilled in the art, are suitable as inhibitors. The inhibitors are preferably selected from phenolic compounds and non-phenolic compounds, such as stable radicals and/or phenothiazines.

Phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), trimethyl-2,4,6-tris(3,5-di-tert-butyl-4-hydroxybenzyl)benzene, 2,2′-methylene-di-p-cresol, pyrocatechol and butylpyrocatechols such as 4-tert-butylpyrocatechol, 4,6-di-tert-butylpyrocatechol, hydroquinones such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof, are suitable as phenolic inhibitors.

Phenothiazines such as phenothiazine and/or derivatives or combinations thereof, or stable organic radicals such as galvinoxyl and N-oxyl radicals, are considered as non-phenolic or anaerobic inhibitors, i.e. inhibitors that are effective even without oxygen, in contrast to the phenolic inhibitors.

Examples of N-oxyl radicals which can be used are those described in DE 199 56 509. Suitable stable N-oxyl radicals (nitroxyl radicals) can be selected from 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxy-piperidine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine, and diethylhydroxylamine. Further suitable N-oxyl compounds are oximes, such as acetaldoxime, acetone oxime, methyl ethyl ketoxime, salicyloxime, benzoxime, glyoximes, dimethylglyoxime, acetone-O-(benzyloxycarbonyl) oxime and the like.

These compounds are particularly expedient and usually necessary, because otherwise the desired storage stability of preferably more than 3 months, in particular 6 months or more, cannot be achieved. UV stability and in particular storage stability can thus be increased considerably.

Furthermore, pyrimidinol or pyridinol compounds substituted in para-position to the hydroxyl group, as described in patent DE 10 2011 077 248 B1, can be used as inhibitors.

Preferred inhibitors are 1-oxyl-2,2,6,6-tetramethylpiperidine (TEMPO) and 1-oxyl-2,2,6,6-tetramethylpiperidin-4-ol (TEMPOL), catechols, particularly preferably tert-butyl-pyrocatechol and Brenzk; the desired properties are achieved by means of the functional group (compared to the reactive diluents otherwise used), BHT and phenothiazine.

The inhibitors can be used either alone or as a combination of two or more thereof, depending on the desired properties of the reaction resin system. The combination of the phenolic and the non-phenolic inhibitors allows a synergistic effect, as is also shown by the setting of a substantially drift-free setting of the gel time of the reaction resin composition.

The inhibitor can be contained in the reaction resin system in an amount of 0 to 5 wt. %, preferably 0.001 to 3 wt. %, particularly preferably 0.01 to 1 wt. %, based on the resin component. If several inhibitors are contained, the amount just mentioned corresponds to the total amount of inhibitors.

According to an embodiment, the resin component contains inorganic added substances, such as fillers and/or other additives.

The fillers used are conventional fillers, preferably mineral or mineral-like fillers, such as quartz, glass, sand, quartz sand, quartz powder, porcelain, corundum, ceramics, talc, silicic acid (e.g. fumed silica), silicates, clay, titanium dioxide, chalk, barite, feldspar, basalt, aluminum hydroxide, granite or sandstone, polymeric fillers such as thermosets, hydraulically curable fillers such as gypsum, quicklime or cement (e.g. alumina cement or Portland cement), metals such as aluminum, carbon black, and also wood, mineral or organic fibers, or the like, or mixtures of two or more thereof, which can be added as a powder, in granular form or in the form of shaped bodies. The fillers may be present in any desired forms, for example as powder or flour, or as shaped bodies, for example in cylindrical, annular, spherical, platelet, rod, saddle or crystal form, or else in fibrous form (fibrillar fillers), and the corresponding base particles preferably have a maximum diameter of 10 mm. However, the globular, inert substances (spherical form) have a preferred and more pronounced reinforcing effect,

Fillers are present in the resin component preferably in an amount of 0.01 to 90, in particular 0.01 to 60, in particular 0.01 to 50 wt. %.

Further conceivable additives are also rheology additives such as optionally organically after-treated fumed silica, bentonites, alkyl- and methylcelluloses, castor oil derivatives or the like, plasticizers such as phthalic or sebacic acid esters, stabilizers, antistatic agents, thickeners, flexibilizers, hardening catalysts, rheology aids, wetting agents, coloring additives such as dyes or in particular pigments, for example for different staining of components for improved control of their mixing, or the like, or mixtures of two or more thereof. Non-reactive diluents (solvents) can also be present, preferably in an amount of up to 30 wt. %, based on the relevant component (reaction resin mortar, hardener), for example from 1 to 20 wt. %, such as low-alkyl ketones, e.g, acetone, di-low-alkyl low-alkanoyl amides such as dimethylacetamide, low-alkylbenzenes, such as xylenes or toluene, phthalic acid esters or paraffins, or water.

In an embodiment of the invention, in addition to the radically curable compound present, the resin component also contains a hydraulically setting or polycondensable inorganic compound, in particular cement. Such hybrid mortar systems are described in detail in DE 42 31 161 A1. In this case, the resin component preferably contains, as a hydraulically setting or polycondensable inorganic compound, cement, for example Portland cement or aluminate cement, with cements which are free of transition metal oxide or have a low level of transition metal being particularly preferred. Gypsum can also be used as a hydraulically setting inorganic compound as such or in a mixture with the cement. The resin component may also comprise silicatic, polycondensable compounds, in particular soluble, dissolved and/or amorphous-silica-containing substances such as fumed silica, as the polycondensable inorganic compound.

The hydraulically setting or polycondensable compound can be contained in the reaction resin system in an amount of 0 to 30 wt. %, preferably 1 to 25 wt. %, particularly preferably 5 to 20 wt. %, based on the resin component.

As already described, if the viscosity and storage stability of the hardener composition are not adversely affected, the hardener component can also contain fillers and/or inorganic additives, the fillers and additives being the same as those just mentioned.

In order to ensure fast and reliable mixing when using thread-forming screws and to ensure clean and safe handling when using thread-forming screws, it is necessary to keep the viscosity not only of the hardener component but also of the resin component as low as possible, but at the same time to allow a high viscosity of the mass after mixing the resin component and the hardener component. This allows the screws to be set cleanly and safely without the risk of contaminating the user or the direct work environment.

In a particularly preferred embodiment, the resin component therefore contains an inorganic filler having hydrophilic properties.

Here, the surfaces in particular, but also the internal constituents of the fillers, can have hydrophilic properties. “Hydrophilic properties” means that the fillers interact with water or can react with water. This ensures that immediately after mixing the resin component and the water-containing hardener component, the resulting mass becomes so viscous that it becomes stable and thus no longer runs out of the borehole, which is particularly advantageous for overhead fixings or wall fixings. In particular, the surfaces of the inorganic fillers can be modified by means of hydrophilic coatings, primers or seals.

Examples of inorganic fillers having hydrophilic properties include those whose surface is treated with a hydrophilic surface treatment agent. Examples of such hydrophilic surface treatment agents include, inter alia, silane surface treatment agents, titanate surface treatment agents, aluminum surface treatment agents, zirconium aluminate surface treatment agents, Al₂O₃, TiO₂, ZrO₂, silicone and aluminum stearate, of which a silane surface treatment agent is preferred.

According to a further preferred embodiment of the multi-component reaction resin system according to the invention, the inorganic filler comprises minerals, selected from a group consisting of alkaline earth metals and the salts thereof, bentonite, carbonates, silicas, silica gel, salts of alkaline earth metals with silica and silicates, in particular silicas.

The inorganic filler can be produced by a dry method such as vapor deposition or combustion, or by a wet method such as precipitation. A commercially available product can also be used. Taking into account the rheological properties of the reaction resin system, the hydrophilic inorganic filler is preferably a fine filler having a surface area of more than 80 m²/g, preferably more than 150 m²/g and more preferably between 150 and 400 m²/g.

According to a further preferred embodiment of the multi-component reaction resin system according to the invention, the inorganic filler comprises a silicon oxide-based filler.

According to a further particularly preferred embodiment of the multi-component reaction resin system according to the invention, the inorganic filler comprises a silica.

The silica is not limited to any particular type or its production. The silica can be a natural or a synthetic silica.

The silica is preferably an amorphous silica, which is selected from the group consisting of colloidal silica, wet-chemically produced silicas such as precipitated silicas, silica gels, silica sols, pyrogenic or thermally produced silicas, which are produced e.g. in an arc, plasma or by flame hydrolysis, silica smoke, silica glass (quartz glass), fused silica (fused quartz) and skeletons of radiolarians and diatoms in the form of kieselguhr.

The proportion of hydrophilic inorganic filler depends on the desired properties of the multi-component reaction resin system. The hydrophilic inorganic filler is usually used in an amount of 0 to 15 wt. %, preferably 0.1 to 10 wt. % and particularly preferably in the range of 1 to 7 wt. %, based in each case on the resin component, the total filler content being in the above-mentioned range, namely in the range from 0.01 to 90, in particular 0.01 to 60, especially 0.01 to 50 wt. %, based on the resin component.

In the embodiments described below, the given quantities (wt. %) in each case relate to the individual components, i.e. the resin component and the hardener component, unless otherwise stated. The actual amounts are such that the wt. % of each component adds up to 100.

In a preferred embodiment of the hardener composition according to the invention, said composition contains:
at least one hardening agent, which is a solid peroxide,
water; and
a rheology additive based on phyllosilicate.
   In a preferred aspect of this first embodiment, the solid peroxide is suspended in the water.

In a further preferred embodiment of the hardener composition according to the invention, said composition contains:
at least one hardening agent, which is a solid peroxide,
water, and
as a rheology additive based on a swellable phyllosilicate.
   In a preferred aspect of this embodiment, the solid peroxide is suspended in the water.

In an even more preferred embodiment of the hardener composition according to the invention, said composition contains:
at least one hardening agent, which is a solid peroxide,
water, and
a rheology additive based on a swellable magnesium aluminum silicate or sodium aluminum silicate.
   In a preferred aspect of this embodiment, the solid peroxide is suspended in the water.

In a very particularly preferred embodiment of the hardener composition according to the invention, said composition contains:
at least one hardening agent, which is a solid peroxide, in particular dibenzoyl peroxide,
water, and
bentonite as a rheology additive based on a swellable phyllosilicate.
   In a preferred aspect of this embodiment, the solid peroxide is suspended in the water.

The hardener composition according to the invention can be used as a hardener component in a reaction resin system.

In a first preferred embodiment of such a reaction resin system, the resin component contains:
at least one radically curable compound and
at least one inorganic filler,
   and the hardener component contains:
at least one hardening agent, which is a solid peroxide;
water; and
a rheology additive based on phyllosilicate.

In a preferred aspect of this first embodiment, the solid peroxide is suspended in the water. In a more preferred aspect, the reaction resin is stabilized by an inhibitor and/or the gel time of the mixture of resin component and hardener component is adjusted by means of an—optionally further—inhibitor. In a further preferred aspect of this first embodiment, the resin component contains:
10 to 99.99 wt. %, preferably 15 to 97 wt. %, particularly preferably 30 to 95 wt. %, of the at least one radically curable compound, and
0.01 to 90 wt. %, preferably 3 to 85 wt. %, particularly preferably 5 to 70 wt. %, of the at least one inorganic filler,
   and the hardener component contains:
2 to 50 wt. %, preferably 5 to 45 wt. %, particularly preferably 10 to 40 wt. %, of the at least one hardening agent, which is a peroxide, and
50 to 98 wt. %, preferably 55 to 95 wt. %, particularly preferably 60 to 90 wt. %, water, and
0.15 to 5 wt. %, preferably 1 to 3 wt. %, of the rheology additive based on phyllosilicate.

In a further preferred second embodiment of the reaction resin system, the resin component consequently contains:
at least one reaction resin mixture of at least one reaction resin and at least one reactive diluent as a radically curable compound: and
at least one inorganic filler,
   and the hardener component contains:
at least one hardening agent, which is a solid peroxide,
water, and
a rheology additive based on phyllosilicate.

In a preferred aspect of this second embodiment, the solid peroxide is suspended in the water. In a further preferred aspect of this second embodiment, the resin component contains:
85 to 99.99 wt. %, preferably 90 to 99.9 wt. %, particularly preferably 93 to 99 wt. %, of a mixture, the reaction resin mixture, consisting of 0 to 99.9 wt. %, preferably 20 to 80 wt. %, based on the total weight of the mixture, of the at least one reactive resin and 0 to 99.99 wt. %, preferably 80 to 20 wt. %, based on the total weight of the mixture, of the at least one reactive diluent as a radically curable compound, and
0.01 to 15 wt. %, preferably 0.1 to 10 wt. %, particularly preferably 1 to 7 wt. %, of the at least one inorganic filler,
   and the hardener component contains:
2 to 50 wt. %, preferably 5 to 45 wt. %, particularly preferably 10 to 40 wt. %, of the at least one peroxide as the hardening agent and
50 to 98 wt. %, preferably 55 to 95 wt. %, particularly preferably 60 to 90 wt. %, water
0.15 to 5 wt. %, preferably 1 to 3 wt. %, of the rheology additive based on phyllosilicate.

In a further preferred third embodiment of the reaction resin system, the resin component contains:
a reaction resin mixture of at least one reaction resin and a reactive diluent as a radically curable compound,
at least one inhibitor,
at least one accelerator, and
at least one inorganic filler,
   and the hardener component contains:
at least one hardening agent, which is a solid peroxide,
water, and
a rheology additive based on phyllosilicate.

In a preferred aspect of this third embodiment, the solid peroxide is suspended in the water. In a further preferred aspect of this third embodiment, the resin component contains:
85 to 99.99 wt. %, preferably 90 to 99.9 wt. %, particularly preferably 93 to 99 wt. %, of a mixture, the reaction resin mixture, consisting of 0 to 99.9 wt. %, preferably 20 to 80 wt. %, based on the total weight of the mixture, of the at least one reactive resin and 0 to 99.99 wt. %, preferably 80 to 20 wt. %, based on the total weight of the mixture, of the at least one reactive diluent as a radically curable compound, and
0.011 to 5 wt. %, preferably 0.01 to 3 wt. %, particularly preferably 0.1 to 1 wt. %, of the at least one inorganic filler,
0.01 to 10 wt. %, preferably 0.5 to 5 wt. %, more preferably 1 to 3 wt. %, of the at least one accelerator,
0.001 to 5 wt. %, preferably 0.01 to 3 wt. %, more preferably 0.1 to 1 wt. %, of the at least one inhibitor, and
   and the hardener component contains:
2 to 50 wt. %, preferably 5 to 45 wt. %, particularly preferably 10 to 40 wt. %, of the at least one peroxide as the hardening agent,
50 to 98 wt. %, preferably 55 to 95 wt. %, particularly preferably 60 to 90 wt. %, water, and
0.15 to 5 wt. %, preferably 1 to 3 wt. %, of the rheology additive based on phyllosilicate.

In a preferred aspect of this embodiment, the viscosity of the mixture of the resin component and the hardener component is adjusted by the inorganic additive such that the mixture becomes stable immediately after mixing. In a further preferred fourth embodiment of the reaction resin system, the resin component consequently contains:
at least one reaction resin mixture consisting of at least one reaction resin and a reactive diluent as a radically curable compound,
at least one inhibitor,
at least one accelerator, and
at least one inorganic filler having hydrophilic properties,
   and the hardener component contains:
at least one hardening agent, which is a solid peroxide,
water, and
a rheology additive based on phyllosilicate.

In a preferred aspect of this fourth embodiment, the solid peroxide is suspended in the water. In a further preferred aspect of this fourth embodiment, the reaction resin system contains the constituents specified in more detail in the amounts given in the third aspect.

In a particularly preferred fifth embodiment of the reaction resin system, the resin component contains:
at least one compound based on urethane (meth)acrylate as the reaction resin,
at least one reactive diluent,
at least one inhibitor,
at least one accelerator, and
at least one inorganic filler having hydrophilic properties,
   and the resin component contains:
at least one hardening agent, which is a solid peroxide,
water, and
as a rheology additive based on a swellable phyllosilicate.

In a preferred aspect of this embodiment, the solid peroxide is suspended in the water. In a further preferred aspect of this fifth embodiment, the reaction resin system contains the constituents specified in more detail in the amounts given in the third aspect.

In a more particularly preferred sixth embodiment of the reaction resin system, the resin component contains:
at least one compound based on urethane (meth)acrylate reaction resin,
at least one reactive diluent,
at least one inhibitor,
at least one accelerator, and
at least one inorganic filler having hydrophilic properties,
   and the resin component contains:
at least one hardening agent which is a solid peroxide, in particular dibenzoyl peroxide,
water, and
a rheology additive based on a swellable magnesium aluminum silicate or a sodium aluminum silicate.

In a preferred aspect of this embodiment, the solid peroxide is suspended in the water. In a further preferred aspect of this sixth embodiment, the reaction resin system contains the constituents specified in more detail in the amounts given in the third aspect.

In a particularly preferred seventh embodiment of the reaction resin system, the resin component adheres to:
at least one compound based on urethane (meth)acrylate as the reaction resin,
at least one reactive diluent,
at least one inhibitor,
at least one accelerator, and
at least one inorganic filler having hydrophilic properties, a hydrophilic fumed silica as the inorganic filler having hydrophilic properties,
   and the resin component contains:
at least one hardening agent which is a solid peroxide, in particular dibenzoyl peroxide,
water, and
bentonite as a phyllosilicate-based rheology additive.

In a preferred aspect of this embodiment, the solid peroxide is suspended in the water. In a further preferred aspect of this seventh embodiment, the reaction resin system contains the constituents specified in more detail in the amounts given in the third aspect.

In a particularly preferred eighth embodiment of the reaction resin system, the resin component adheres to:
at least one compound based on urethane (meth)acrylate as the reaction resin,
at least one reactive diluent.
at least one inhibitor,
at least one accelerator, and
at least one hydrophilic fumed silica as an inorganic filler with hydrophilic properties,
   and the resin component contains:
at least one hardening agent which is a solid peroxide, in particular dibenzoyl peroxide,
water, and
bentonite as a phyllosilicate-based rheology additive.

In a preferred aspect of this embodiment, the solid peroxide is suspended in the water. In a further preferred aspect of this eighth embodiment, the reaction resin system contains the constituents specified in more detail in the amounts given in the third aspect.

According to the invention, the rheology additive based on a phyllosilicate is used in a multi-component reaction resin system, typically a two-component system. This multi-component system may be in the form of a cartridge system or a film pouch system. The reaction resin system is used with thread-forming screws in holes. The holes can be depressions of natural or non-natural origin, i.e. cracks, crevices, boreholes and the like. These are typically boreholes, in particular boreholes in various substrates, in particular mineral substrates, such as those based on concrete, aerated concrete, brickwork, sand-lime brick, sandstone, natural stone, glass and the like, and metal substrates such as those made of steel.

The reaction resin system, in which, according to the invention, the swellable phyllosilicate is used as a rheology additive, is used according to the invention with thread-forming screws in holes. The holes can be depressions of natural or non-natural origin, i.e. cracks, crevices, boreholes and the like. These are typically boreholes, in particular boreholes in various substrates, in particular mineral substrates, such as those based on concrete, aerated concrete, brickwork, limestone, sandstone, natural stone, glass and the like, and metal substrates such as those made of steel.

The reaction resin composition, in which the swellable phyllosilicate is used according to the invention as a rheology additive, is characterized by a low viscosity of the component containing this additive and an increased storage stability of the component compared to embodiments without the rheology additive used or to embodiments with other rheology additives which do not contain phyllosilicate.

The invention is explained in greater detail in the following with reference to a number of examples and comparative examples. All examples support the scope of the claims. However, the invention is not limited to the specific embodiments shown in the examples.

### EMBODIMENTS

List of the Constituents used in the Examples and References (Explanation of Abbreviations) as well as their Trade Names and Sources of Supply:
Aerosil® 200 hydrophilic fumed silica; Evonik (CAS no: 112945-52-5, specific surface area 200 m²/g; average particle size 0.2-0.3 μm (aggregates)
Optigel-CK activated phyllosilicate (bentonite); BYK-Chemie GmbH (specific density 2.6 g/cm³, bulk density 550-750 kg/m³, moisture content 10%±2%)
Optigel-WX activated phyllosilicate (bentonite) with xanthan gum; BYK-Chemie GmbH (specific density 2.2 g/cm³, bulk density 500-650 kg/m³, moisture content max. 13%)
Xanthan gum XGT TNAS xanthan gum, Jungbunzlauer Austria AG (CAS No. 11138-66-2)
BP20SAQ dibenzoyl peroxide 20%, suspension in water; United Initiators GmbH & Co. KG

Mixtures of benzoyl peroxide, 20% aqueous suspension, with different thickeners in different concentrations, as indicated in table 1, were prepared by initially introducing the benzoyl peroxide suspension and adding the relevant additive. The mixture was first pre-stirred by hand and then mixed in a speed mixer (High Speed Mixer DAC 400 FVZ; Hauschild & Co. KG) according to the following program until the thickener was well incorporated:
Mixing program: 10 sec. at 1000 rpm,
   20 sec. at 2500 rpm.
   15 sec. at 1500 rpm.

Measurement of the Dynamic Viscosity of the Hardener-Thickener Mixtures (Hardener Compositions)

The dynamic viscosity of the hardener-thickener mixtures according to the invention (hardener compositions) (table 1) was measured using a plate-cone measuring system (HAAKE® RheaStress® RS600 with temperature control unit UTC-20. measuring geometry 020/1° Ti L01 026) according to DIN 53019. The diameter of the cone was 20 mm, the angle was 1° and the gap was 0.052 mm. Measurement was carried out at a constant shear rate of 25 rpm at a temperature of 23° C., The measurement time was 180 s. In order to achieve the shear rate, the sample was first held at 23° C. for 30 s, then a ramp of 0-25 rpm with a duration of 120 s was connected upstream. Since these are Newtonian liquids, a linear evaluation over the measuring stage was made at a constant shear rate of 100/s over the measuring stage and the viscosity was determined. In each case three measurements were made; the mean values are each indicated in Table 1.

TABLE 1
Composition of the hardener compositions according to the invention and results of the viscosity measurements of
the freshly prepared hardener compositions according to the invention and after 16 weeks of storage at 40° C.

| | | Freshly prepared hardener composition | | Hardener composition according to the | |
|---|---|---|---|---|---|
| | Proportion | according to the invention | | invention after storage for 16 weeks at 40° C. | |
| | of thickener | Viscosity | | Viscosity | |
| Thickener | [wt. %] | [mPa · s] | Assessment of consistency | [mPa · s] | Assessment of consistency |
| Optigel CK | 1 | 136 | flowable, slight demulsification | 175 | no sedimentation, flowable |
| Optigel CK | 2 | 155 | flowable, slight demulsification | 203 | no sedimentation, flowable, |
| Optigel CK | 3 | 192 | still flowable, slight demulsification | 250 | no sedimentation, flowable |
| Optigel CK | 4 | 249 | still flowable | 325 | no sedimentation, still flowable |

TABLE 2
Composition of the comparative hardener compositions and results of the viscosity measurements of
the freshly prepared comparative hardener compositions and after 16 weeks of storage at 40° C.

| | | Freshly prepared comparative hardener | | Comparative hardener compositions after | |
|---|---|---|---|---|---|
| | Proportion | compositions | | storage for 16 weeks at 40° C. | |
| | of thickener | Viscosity | | Viscosity | |
| Thickener | [wt. %] | [mPa · s] | Assessment of consistency | [mPa · s] | Assessment of consistency |
| Without ¹⁾ | 0 | 121 | | | |
| Aerosil 200 | 0.5 | 155 | flowable | not measured | heavy sedimentation |
| Aerosil 200 | 1 | 186 | flowable, slightly thickened | not measured | heavy sedimentation |
| Aerosil 200 | 2 | 355 | no longer flowable | 338 | thickened, some liquid settled on top |
| Aerosil 200 | 3 | 694 | not flowable, still usable | 430 | thickened, some liquid settled on top |
| Aerosil 200 | 4 | 883 | like no. 3, but more viscous | 530 | very highly thickened, liquid settled |
| Optigel WX | 0.15 | 163 | good flowability, somewhat thickened | not measured | sedimentation |
| Optigel WX | 0.25 | 170 | flowable, thickened | not measured | sedimentation |
| Optigel WX | 0.5 | 200 | still flowable but quite highly | not measured | sedimentation |
| | | | thickened | | |
| Xanthan gum | 0.1 | 135 | flowable | not measured | sedimentation |
| XGT TNAS | | | | | |
| Xanthan gum | 0.15 | 152 | flowable | not measured | sedimentation |
| XGT TNAS | | | | | |
| Xanthan gum | 0.25 | 215 | flowable, slightly too thick | not measured | sedimentation |
| XGT TNAS | | | | | |
| Xanthan gum | 0.5 | 329 | flowable, but too thick | not measured | sedimentation |
| XGT TNAS | | | | | |
| Xanthan gum | 1 | 480 | no longer flowable, too solid | 480 | no sedimentation, not flowable |
| XGT TNAS | | | | | |

¹⁾ 100% BP20SAQ

The results of the measurements of dynamic viscosity shown in table 1 show that the freshly prepared hardener compositions according to the invention have a viscosity in the range of from 136 mPa·s to 249 mPa·s, depending on the amount used, and were thus still flowable. After storage for 16 weeks at 40° C., no sedimentation of the peroxide was observed and the hardener compositions were all flowable, even with a thickener content of 4 wt. %.

The results of the measurements of dynamic viscosity shown in table 2 show that the freshly prepared comparative hardener compositions were in some cases still flowable, depending on the amount of thickener used. However, some of the comparative hardener compositions had such a high viscosity that they were no longer flowable. After storage for 16 weeks at +40° C., some of the comparison hardener compositions were very much thickened and settling of the solid peroxide was observed. In the other part, sedimentation of the peroxide was observed. Storage stability was therefore not provided.

The results, shown in tables 1 and 2, of the measurements of the dynamic viscosity of the hardener compositions according to the invention (table 1) and the comparative hardener compositions (table 2) show that the hardener compositions according to the invention remained flowable after storage and showed no sedimentation compared with the comparative hardener compositions.

It was thus possible to develop a hardener composition which, when using aqueous peroxide suspensions, could ensure the storage stability of the component.

1. A hardener composition for a reaction resin system based on a radically curable compound, the hardener composition comprising:
water,
a solid peroxide, and
a rheology additive,
wherein the rheology additive is based on a phyllosilicate.

2. The hardener composition according to claim 1, wherein the phyllosilicate is a swellable phyllosilicate.

3. The hardener composition according to claim 2, wherein the swellable phyllosilicate is a magnesium aluminum silicate or a sodium aluminum silicate.

4. The hardener composition according to claim 2, wherein the rheology additive consists of the swellable phyllosilicate, or wherein the rheology additive comprises the swellable phyllosilicate in an amount of more than 50 wt. %, based on a weight of the rheology additive.

5. The hardener composition according to claim 4, wherein the theology additive is montmorillonite, or wherein the rheology additive comprises the montmorillonite in an amount of more than 50 wt. %, based on a weight of the rheology additive.

6. The hardener composition according to claim 5, wherein the rheology additive is bentonite.

7. The hardener composition according to claim 1, wherein the rheology additive is contained in an amount of 0.15 to 5 wt. %, based on a total weight of the hardener composition.

8. The hardener composition according to claim 1, wherein the water and the solid peroxide are present in a form of a suspension.

9. The hardener composition according to claim 1, wherein the solid peroxide is selected from the group consisting of diacetyl peroxide, di-p-chlorobenzoyl peroxide, phthaloyl peroxide, succinyl peroxide, dilauryl peroxide, acetylcyclohexanesulfonyl peroxide, cyclohexane percarbonate, bis(4-t-butylcyclohexyl)percarbonate, silicon peroxide, cyclohexane peroxide, dibenzoyl peroxide, and dilauroyl peroxide.

10. A multi-component reaction resin system, comprising:
a resin component comprising a radically curable compound, and
a hardener component comprising the hardener composition according to claim 1.

11. The multi-component reaction resin system according to claim 10, wherein the radically curable compound comprises at least one reaction resin, at least one reactive diluent, or a mixture of the at least one reaction resin and the at least one reactive diluent.

12. The multi-component reaction resin system according to claim 11, wherein the reaction resin is a compound based on urethane (meth)acrylate, epoxy (meth)acrylate, a methacrylate of an alkoxylated bisphenol, or an ethylenically unsaturated compound.

13. The multi-component reaction resin system according to claim 10, wherein the resin component further comprises an inorganic substance.

14. The multi-component reaction resin system according to claim 13, wherein the inorganic substance has hydrophilic properties.

15. The multi-component reaction resin system according to claim 10, wherein the resin component further comprises an inhibitor and/or an accelerator.

16. The multi-component reaction resin system according to claim 10, wherein the multi-component reaction resin system is a two-component bag system.

17. A method, comprising:
fastening and/or reinforcing a thread-forming screw in a solid substrate with the multi-component reaction resin system according to claim 10.

18. The method according to claim 17, wherein the solid substrate is stone or concrete.
